(19) United States
(12) Patent Application Publication
(10) Pub. No.: US 2004/0119369 A1
(43) Pub. Date: Jun. 24, 2004

(54) Collector ring assembly for rotor shaft of electrical machine

(76) Inventor: David E. Radtke, New London, WI (US)

Correspondence Address: OSTRAGER CHONG & FLAHERTY LLP, 825 THIRD AVE, 30TH FLOOR, NEW YORK, NY, 10022-7519, US

(21) Appl. No.: 10/322,938

(22) Filed: Dec. 18, 2002

(51) Int. Cl. H01R 39/00; H02K 1/00

(52) U.S. Cl. 310/232; 439/13

(57) ABSTRACT

A rotor assembly having a rotor shaft, a rotor winding mounted to the rotor shaft, an electrically insulative body mounted to the rotor shaft, an electrically conductive collector ring supported by the electrically insulative body, a wire lead electrically connecting the winding to the collector ring, and a fastener engaged with a boss of the collector ring. The wire lead has a portion that is wrapped around a first portion of the fastener and pressed into contact with the boss of the collector ring by a second portion of the fastener. A collector ring assembly having two or more collector rings is formed by insert molding.

### BACKGROUND OF THE INVENTION

This invention generally relates to conductive rotating rings that, in combination with stationary brushes or contacts, provide a continuous electrical connection between rotating and stationary conductors. Such conductive rotating rings, known as “slip rings” or “collector rings” (the latter term will be used herein) are used in electric rotating machinery (such as electric motors and generators), synchros, gyroscopes and scanning radar antennas.

A typical electric motor or generator comprises a rotor shaft, a rotor having field windings and rotor end caps. For supplying and withdrawing electrical current to and from the rotor windings, a collector ring arrangement is provided on the rotor shaft. Typically, a pair of collector rings are mounted to and rotate with the rotor shaft. The collector rings are electrically isolated from the rotor shaft, but are in electrical contact with the leads of the rotor winding.

A known collector ring arrangement comprises an electrically insulative body that is pressed outside or between the bearings that support the rotor shaft. The collector rings, which are made of an electrically conductive material such as copper metal or alloy, are inserted into a mold in a mutually coaxial relationship and then the electrically insulative material is injected into the mold with the inserts in place. The result is a collector ring assembly in which the rings are embedded in the outer portion of a molded electrically insulative body that is pressed onto a rotor shaft. As the rotor shaft rotates, brushes or contacts stay in contact with the outer peripheral surfaces of the collector rings, maintaining electrical connections.

In the foregoing example, each collector ring must be electrically connected to a respective wire lead of the rotor winding. In a known welder/generator unit, each collector ring is made of copper or other electrically conductive alloy and comprises a circular band and a boss having a hole. The boss of each collector ring is directed away from the other collector ring. One lead of the rotor winding is in electrical contact with the surface of the boss of the near (closest to the winding) collector ring, that contact surface being located on the near side of the collector ring assembly, while the other lead of the rotor winding is in electrical contact with the surface of the boss of the far (furthest from the winding) collector ring, that contact surface being located on the far side of the collector ring assembly. In the latter instance, the wire lead passes through an axial hole formed in the molded electrically insulative body that supports the collector rings in mutually coaxial and electrically isolated positions. In each instance, the electrical connection is made via a respective ring terminal that is crimped onto the end of the respective wire lead of the rotor winding. The ring-shaped contact portion of each ring terminal is pressed against the respective boss surface by the head of a respective fastener that is screwed into a respective hole formed in each boss. The shaft of the fastener is passed through the ring-shaped contact portion and then screwed tightly into the hole until the ring terminal is pressed by the fastener head into contact with the peripheral surface on the boss that surrounds the hole. In this manner, each collector ring can be electrically connected to a respective lead of the rotor winding.

There is a need for a method of electrically connecting collector rings to rotor winding leads that does not require the use of ring terminals. The elimination of the ring terminals would reduce the cost of manufacturing a rotating electrical machine.

### BRIEF DESCRIPTION OF THE INVENTION

The invention is directed to a collector ring assembly for electrical connection of rotor winding leads. The invention is also directed to structural aspects of the collector rings incorporated in that assembly and to a method for electrically connecting a rotor winding lead to a collector ring.

One aspect of the invention is a rotor assembly comprising a rotor shaft, a rotor winding mounted to the rotor shaft, an electrically insulative body mounted to the rotor shaft, an electrically conductive collector ring supported by the electrically insulative body and comprising a circular ring and a boss, a wire lead electrically connecting the winding to the collector ring, and a fastener engaged with the boss of the collector ring, wherein the wire lead has a portion that is wrapped around a first portion of the fastener and pressed into contact with the boss of the collector ring by a second portion of the fastener during tightening of the fastener.

Another aspect of the invention is a collector ring assembly comprising first and second electrically conductive collector rings supported by a body of electrically insulative material, each of the first and second collector rings comprising a circular ring and a boss. The boss of the first collector ring comprises a hole and projects generally axially toward and into a space bounded by the circular ring of the second collector ring, while the boss of the second collector ring comprises a hole and projects generally axially toward and into a space bounded by the circular ring of first collector ring. The circular rings of the first and second collector rings are substantially coaxial.

A further aspect of the invention is a method of making electrical connections between the leads of a rotor winding and a pair of electrically conductive collector rings mounted to a rotor shaft on one side of the winding. The method comprises the following steps: (a) threading first and second winding leads through first and second throughholes formed in a body of electrically insulative material that is disposed between and electrically isolates the first and second collector rings from the rotor shaft, the terminal portions of the first and second winding leads being disposed on the far side of the electrically insulative body; (b) fastening the terminal portion of the first winding lead in electrical contact with a portion of the first collector ring; and (c) fastening the terminal portion of the second winding lead in electrical contact with a portion of the second collector ring.

In accordance with a further aspect of the foregoing method, the ends of the winding leads are wrapped around first portions of respective fastener and pressed against portions of the first and second collector rings respectively by second portions of the respective fasteners.

Another aspect of the invention is a collector ring made of metal alloy and comprising a circular ring having a central axis and a boss integrally formed with and disposed radially inward from the circular ring and projecting away from the circular ring in parallel with the central axis, the boss comprising an axial throughhole.

Yet another aspect of the invention is a rotor assembly comprising a rotor shaft, a rotor winding mounted to the rotor shaft and comprising first and second winding leads, and a collector ring assembly mounted to the rotor shaft on one side of the winding, wherein the first and second winding leads respectively pass through first and second tunnels formed in the collector ring assembly.

Other aspects of the invention are disclosed and claimed below.

### BRIEF DESCRIPTION OF THE DRAWINGS

FIG. 1 is a drawing showing an isometric view of a collector ring assembly mounted to one end of a rotor shaft in accordance with one embodiment of the present invention.

FIG. 2 is a drawing showing an isometric view of the collector ring assembly with the rotor shaft removed to reveal structure not visible in FIG. 1.

FIG. 3 is a drawing showing an isometric view of the collector ring assembly of FIG. 2 rotated 180 degrees about a radial axis.

FIG. 4 is a drawing showing a plane view of the far end face of the collector ring assembly with one wire lead and one screw not shown on one side of the assembly.

FIG. 5 is a drawing showing an isometric sectional view of the insert-molded collector ring assembly.

FIG. 6 is a drawing showing an isometric view of one collector ring in accordance with the disclosed embodiment of the invention.

FIG. 7 is a drawing showing an isometric view of the two collector rings with the electrically insulative molded body removed so that the positional relationship of the collector rings to each other can be seen.

Reference will now be made to the drawings in which similar elements in different drawings bear the same reference numerals.

### DETAILED DESCRIPTION OF THE INVENTION

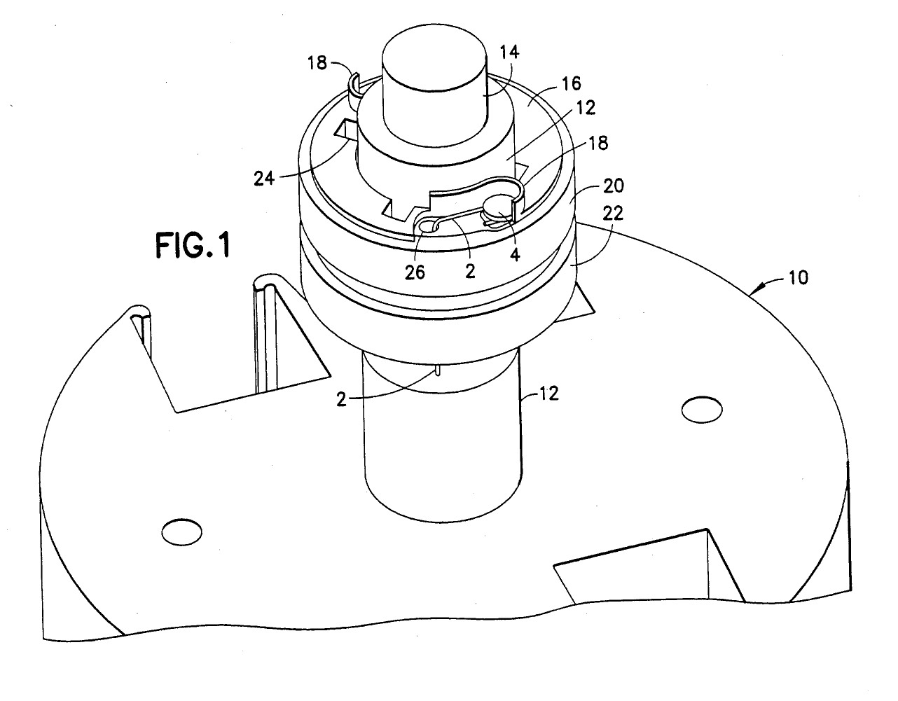

A rotor assembly in accordance with one embodiment of the invention is depicted in FIG. 1. The rotor assembly comprises a rotor 10 having a rotor shaft 12 and a collector ring assembly mounted to one end of the rotor shaft. The other end of the rotor shaft is not shown in FIG. 1. Also the bearings that rotatably support the rotor shaft 12 are not shown. One set of bearing would be seated on the reduced-diameter portion 14 of the shaft. In addition, the rotor winding is not shown in FIG. 1. The collector ring assembly comprises an electrically insulative body 16 mounted to the rotor shaft 12 and a pair of collector rings 20, 22 joined to the electrically insulative body 16 during insert molding (a process that will be described in more detail later). Each collector ring is made of copper alloy or other electrically conductive alloy. Each collector ring may be cast or machined from a block of material..

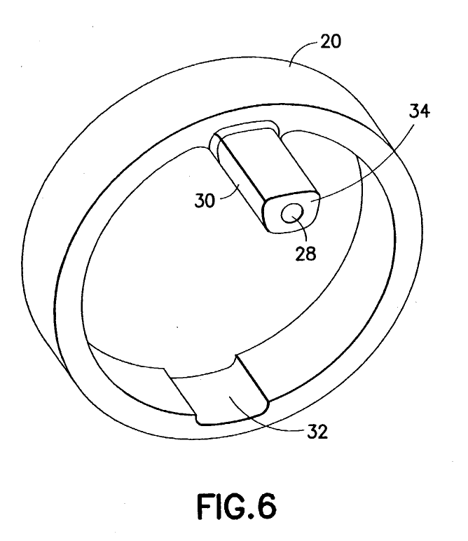

The structure of collector ring 20 is shown in FIG. 6. The other collector ring 22 has a substantially identical structure so that the collector rings are interchangeable. Each collector ring comprises a generally circular cylindrical ring and a generally axially directed boss 30 having a cored axial throughhole 28. The boss 30 projects radially inward from the collector ring 22 and also projects axially away from the collector ring in one direction. Away from the circular ring, the boss 30 has a generally cylindrical structure (i.e., a generally constant cross section).

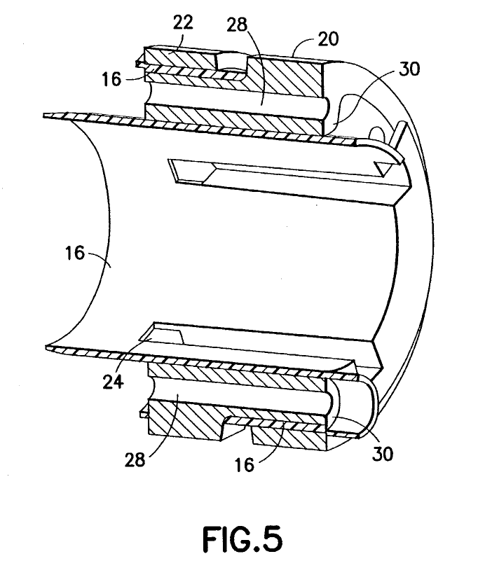

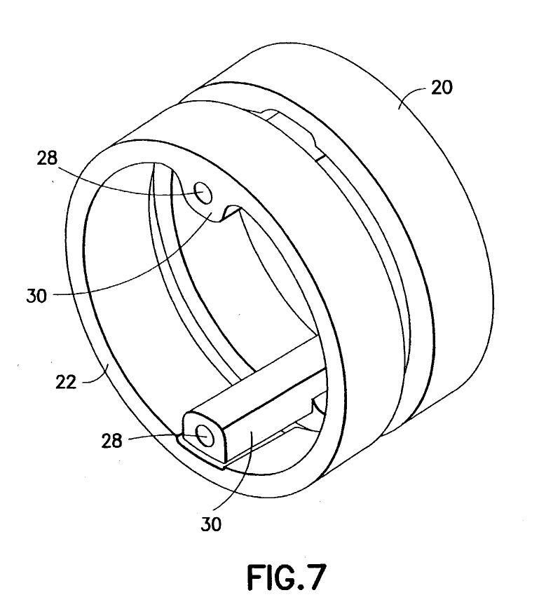

FIG. 7 shows the collector ring assembly with the electrically insulative body removed to reveal the positional relationship of the collector rings in the final assembly. The circular rings themselves are coaxial and spaced apart from each other. As can be seen in FIG. 7, the distal end of the boss 30 of collector ring 20 projects axially into the space bounded by the collector ring 22. Although not visible in FIG. 7, the distal end of boss 30 of collector ring 22 likewise projects axially into the space bounded by the collector ring 20. However, in each case the distal end of the boss is radially spaced from the surrounding circular ring and that space is filled with electrically insulative material when the electrically insulative body is formed by injection molding, as can be seen in FIG. 5. Thus in the final collector ring assembly, the collector rings are electrically isolated from each other. The space separating the ring of one collector ring from the boss of the other collector ring is formed at least in part by providing a relief 32 (see FIG. 6) on the inner circumference of each ring. The relief 32 is disposed diametrally opposite to the boss 30 on the same collector ring. Thus when the collector rings are oriented coaxially with one ring reversed by 180° with respect to the other, the relief on one collector ring faces the boss of the other collector ring across the aforementioned space or gap. It should be appreciated, however, that the collector rings need not be positioned with their respective bosses in diametric opposition. There is no requirement that the winding connections be diametrally opposed to each other.

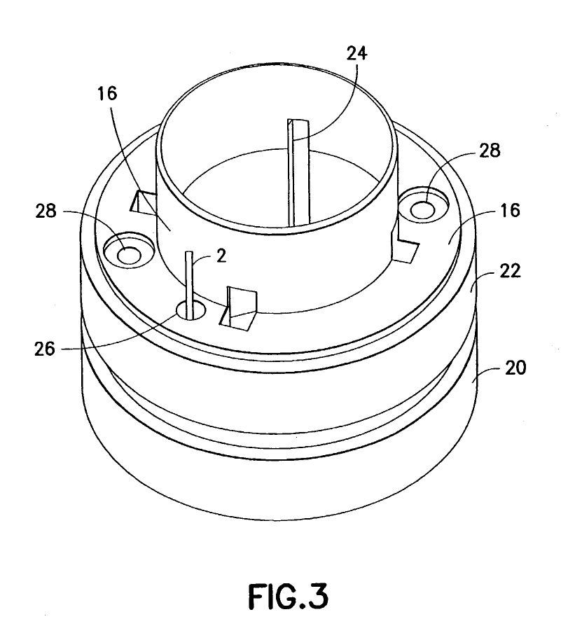

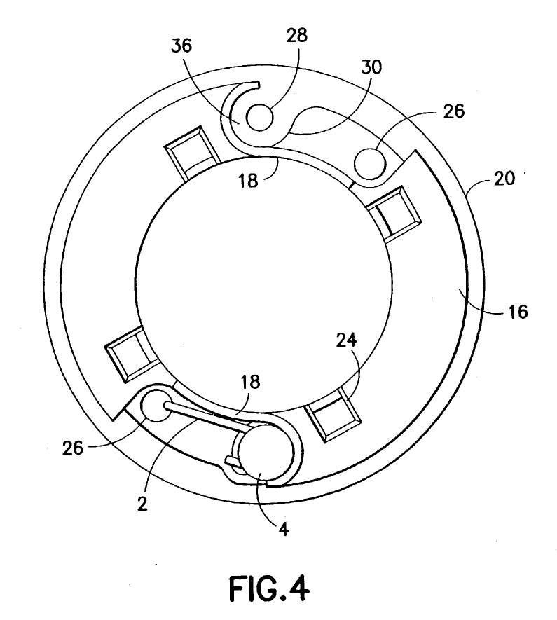

As seen in FIG. 5, the collector rings 20 and 22 are held in their respective positions by a mass of injection-molded electrically insulative material. The injection mold has a cavity shaped to receive the inserted collector rings and then form the electrically insulative body 16 when the open spaces inside the cavity are filled with injected material. The electrically insulative body 16 has a circular cylindrical inner peripheral surface of diameter slightly greater than the outer diameter of the rotor shaft. As best seen in FIG. 3, the body 16 has two portions of different radial thickness, the relatively thicker portion being disposed inside the collector rings and a thin circular cylindrical wall extending axially from one end of the collector ring assembly. As best seen in FIG. 5, the inner circumference of the relatively thicker portion of body 16 is broken by a plurality of axial slots 24, that allow varnish penetration during attachment of the collector ring assembly to the rotor shaft. Four slots 24 are circumferentially distributed at equiangular intervals of 90°. The axially projecting portion of each boss 30 is surrounded by and embedded in the plastic material of body 16. During injection molding, steps must be taken to ensure that the injected material does not enter the axial throughhole 28 of either boss 30. In addition, the electrically insulative body 16 is formed with a pair of cored throughholes 26 disposed at diametrally opposite positions, as seen in FIG. 4. The respective wire leads 2 (only one of which is shown) for connecting the rotor winding are passed through these holes 26. Finally, the electrically insulative body 16 is formed with a pair of wire guards 18 that shield the wire leads 2 from the rotor shaft 12. As best seen in FIG. 4, each wire guard 18 is generally J-shaped, the profile projecting generally axially away from the adjoining end face of the body 16. However, the wire guard may have any other shape that does not allow the wire lead to pinch out from under the head of the screw (described below).

For the purpose of illustration, operation of an electrical generator will be described. However, it should be understood that the collector ring assembly disclosed herein has application in other electrical machines. In an electrical generator for providing electric welding current, the rotor assembly rotates about the axis of the rotor shaft, driven by an internal combustion engine (not shown). Current is supplied to the rotor winding under the control of a field current controller (not shown). The electrical current in the rotating winding induces current into one or more stator windings (not shown), e.g., one winding for providing welding power and another winding for providing auxiliary power for running accessories such as tools, lights and so forth.

To accomplish the foregoing, the field current controller must be electrically connected to the ends or leads of the rotor winding. During operation, the rotor winding is rotating while the field current controller is stationary. In accordance with the disclosed embodiment, one collector ring is electrically connected to one wire lead at one end of the rotor winding and the other collector ring is connected to another wire lead at the other end of the rotor winding. During rotation of the rotor, the collector rings are brushed by electrically conductive brushes that stay in contact with the surfaces of the collector rings throughout the rotation of the latter. These brushes are in turn electrically connected to the field current controller in conventional manner.

In the disclosed embodiment, the electrical connections to the rotor winding are made on the end face of the collector ring assembly that faces away from the rotor winding (hereinafter “far end face”). The far end face of the collector ring assembly is seen in FIG. 1. To reach the far end face, the wire leads of the rotor winding pass through respective throughholes 26 (only one is visible in FIG. 1, but see FIG. 4) formed in the electrically insulative body 16. Each of the two throughholes 26 has a wire lead 2 passed through. In the disclosed embodiment, each wire lead 2 is a respective end of the rotor winding that has had the insulative coating stripped away to expose the conductive wire. One wire lead is electrically connected to collector ring 20 while the other wire lead is electrically connected to collector ring 22.

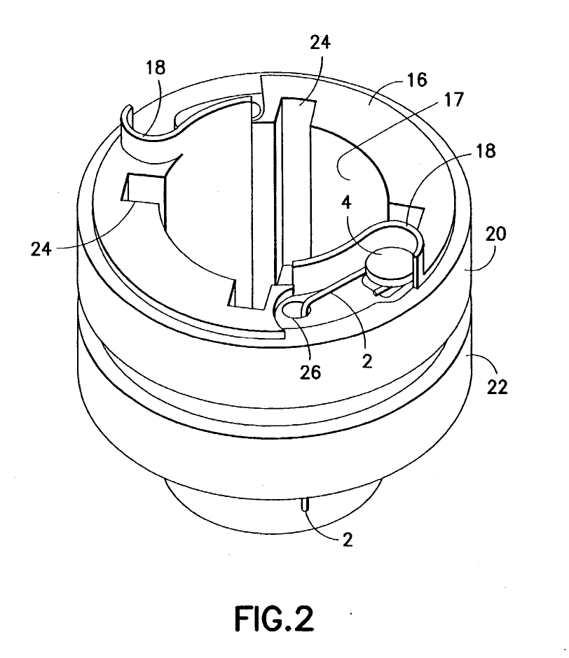

FIGS. 1 and 2 shows the electrical connection of an uninsulated wire lead 2 to the collector ring 22 via contact of an end portion of the lead with an end face 34 (shown in FIG. 6) of the boss 30. A self-threading screw 4 is screwed into the end of the axial hole 28 in the boss 30 that is proximal to the collector ring 20. The wire lead 2 is wrapped around the shaft of the screw 4 and when the screw 4 is tightened, the head of the screw presses the wrapped portion of the wire lead 2 against the end face 34 (seen in FIG. 6) of the boss 30. This establishes electrical contact between the wire lead 2 and the collector ring 22. Alternatively, the end of an insulated wire lead is wrapped around the screw and the end face 34 of the boss 30 is provided with projections (e.g., knurls) that pierce the wire insulation when compressed together by the tightened screw. The insulation-piercing projections on the boss end face establish an electrical connection between the collector ring and the wire lead. Although not shown in any of the drawings, another wire lead is electrically connected to the second collector ring 20 in a similar manner, with the difference that a second fastener (not shown), situated at a diametrally opposite position on the end face of the collector ring assembly, is screwed into the end of the boss of collector ring 20 that is proximal to the collector ring 20. In particular, that second fastener would be screwed into the hole labeled 28 in FIG. 4, which hole is formed in the boss of collector ring 20. The end of the second wire lead is wrapped around the shaft of the second fastener and pressed into electrical contact with the end face 36 of the boss 30 of collector ring 20 by the head of the fastener when the fastener is tightened.

The portion of each wire lead exiting the throughhole 26 in the insulating body 16 and spanning the distance between the hole 26 and the respective fastener 4 is shielded from the metal rotor shaft by a respective electrically insulative wire guard 18.

Although it is economic to manufacture identical collector rings when an assembly consisting of two collector rings is being made, it should be understood that the collector ring on the far side where the winding iwre leads are connected does not require that its boss extend to the near side of the assembly. Furthermore, the collector ring assembly of the invention may have more than two coaxial collector rings electrically isolated from each other. For example, in the case of a collector ring assembly having three collector rings, different boss lengths would be needed in order to electrically connect all three collector rings on one side of the assembly.

While the invention has been described with reference to preferred embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the specification and claims, the term “wire lead” means an end of the winding wire (with or without insulation) or a wire (with or without insulation) connected to the end of the winding wire.

1. A rotor assembly comprising a rotor shaft, a rotor winding mounted to said rotor shaft, an electrically insulative body mounted to said rotor shaft, a first electrically conductive collector ring supported by said electrically insulative body and comprising a circular ring and a boss, a first wire lead electrically connecting said winding to said first collector ring, and a first fastener engaged with said boss of said first collector ring, wherein said first wire lead has a portion that is wrapped around a first portion of said first fastener and pressed into contact with said boss of said first collector ring by a second portion of said first fastener during tightening of said first fastener.

2. The rotor assembly as recited in claim 1, further comprising a second electrically conductive collector ring supported by said electrically insulative body and comprising a circular ring and a boss, a second wire lead electrically connecting said winding to said second collector ring, and a second fastener engaged with said boss of said second collector ring, wherein said second wire lead has a portion that is wrapped around a second portion of said second fastener and pressed into contact with said boss of said second collector ring by a second portion of said second fastener during tightening of said second fastener.

3. The rotor assembly as recited in claim 2, wherein said wrapped terminal portions of said first and second wire leads are both disposed adjacent the same end face of said electrically insulative body.

4. The rotor assembly as recited in claim 3, wherein said electrically insulative body comprises first and second throughholes extending generally axially in said body, said first wire lead being passed through said first throughhole and said second wire lead being passed through said second throughhole.

5. The rotor assembly as recited in claim 1, wherein said boss of said first collector ring comprises a hole, and said first and second portions of said first fastener respectively comprise a threaded shaft and a head, said threaded shaft being disposed inside said hole in said boss of said first collector ring.

6. The rotor assembly as recited in claim 2, wherein said boss of said first collector ring projects generally axially toward and into a space bounded by said second collector ring.

7. The rotor assembly as recited in claim 1, wherein said first wire lead is pressed against a surface of said boss that has projections designed to pierce insulation on said first wire lead.

8. The rotor assembly as recited in claim 6, wherein said boss of said first collector ring is separated from said circular ring of said second collector ring by a portion of said electrically conductive body.

9. The rotor assembly as recited in claim 8, wherein said circular ring of said second collector ring is relieved in an area opposite to said boss of said first collector ring.

10. The rotor assembly as recited in claim 2, wherein said first and second collector rings are electrically isolated from said rotor shaft and from each other by said electrically insulative body.

11. The rotor assembly as recited in claim 2, wherein said first and second collector rings are substantially identical.

12. The rotor assembly as recited in claim 1, wherein said electrically insulative body further comprises a wall that shields said wrapped portion of said first wire lead from said rotor shaft.

13. The rotor assembly as recited in claim 12, wherein said wall has a profile that does not allow said first wire lead to pinch out from under said first portion of said first fastener.

14. The rotor assembly as recited in claim 4, wherein said electrically insulative body further comprises first and second walls that shield said wrapped portions of said first and second wire leads from said rotor shaft.

15. The rotor assembly as recited in claim 1, wherein said electrically insulative body further comprises a generally circular cylindrical axial bore and a plurality of axial slots communicating with said bore, said axial slots being circumferentially distributed along said axial bore.

16. The rotor assembly as recited in claim 2, wherein said circular ring and said boss of said first collector ring are integrally formed from metal alloy, and said circular ring and said boss of said second collector ring are integrally formed from metal alloy.

17. A collector ring assembly comprising first and second electrically conductive collector rings supported by a body of electrically insulative material, each of said first and second collector rings comprising a circular ring and a boss, wherein said boss of said first collector ring comprises a hole and projects generally axially toward and into a space bounded by said circular ring of said second collector ring, while said boss of said second collector ring comprises a hole and projects generally axially toward and into a space bounded by said circular ring of first collector ring, said circular rings of said first and second collector rings being substantially coaxial.

18. The collector ring assembly as recited in claim 17, wherein said circular ring of said second collector ring is relieved in an area opposite to said boss of said first collector ring, while said circular ring of said first collector ring is relieved in an area opposite to said boss of said second collector ring.

19. The collector ring assembly as recited in claim 17, wherein said first and second collector rings are electrically isolated from each other by said electrically insulative body.

20. The collector ring assembly as recited in claim 17, wherein said first and second collector rings are substantially identical.

21. The collector ring assembly as recited in claim 17, wherein said holes in each of said bosses extend generally axially from one end to the other end of said respective boss.

22. The collector ring assembly as recited in claim 17, wherein said electrically insulative body comprises first and second generally axial throughholes, a generally circular cylindrical inner peripheral surface forming an axial bore that is coaxial with said first and second collector rings, and first and second walls projecting generally axially from an end face of said body.

23. The collector ring assembly as recited in claim 22, wherein said first wall comprises a first surface that is generally aligned with and is a continuation of a first portion of said inner peripheral surface, while said second wall comprises a second surface that is generally aligned with and is a continuation of a second portion of said inner peripheral surface.

24. The collector ring assembly as recited in claim 22, wherein each of said first and second walls has a profile that does not allow a wire lead to pinch out from under the head of a fastener inserted in said hole in said boss of said first and second collector rings respectively

25. The collector ring assembly as recited in claim 22, wherein said electrically insulative body further comprises a plurality of axial slots communicating with said axial bore, said axial slots being circumferentially distributed along said axial bore.

26. The collector ring assembly as recited in claim 17, wherein said circular ring and said boss of said first collector ring are integrally formed from metal alloy, and said circular ring and said boss of said second collector ring are integrally formed from metal alloy.

27. A method of making electrical connections between the leads of a rotor winding and a pair of electrically conductive collector rings mounted to a rotor shaft on one side of the winding, comprising the following steps:
threading first and second winding leads through first and second throughholes formed in a body of electrically insulative material that is disposed between and electrically isolates the first and second collector rings from the rotor shaft, the terminal portions of the first and second winding leads being disposed on the far side of the electrically insulative body;
fastening the terminal portion of the first winding lead in electrical contact with a portion of the first collector ring; and
fastening the terminal portion of the second winding lead in electrical contact with a portion of the second collector ring.

28. The method as recited in claim 27, wherein each of said fastening steps comprising the following steps:
wrapping the terminal portion of the respective winding lead around a shaft of a respective fastener; and
screwing the fastener into a hole in the respective collector ring with the wrapped-around portion of the respective winding lead pressed tightly between the head of the respective fastener and an opposing portion of the respective collector ring on the periphery of the hole.

29. A collector ring made of metal alloy and comprising a circular ring having a central axis and a boss integrally formed with and disposed radially inward from said circular ring and projecting away from said circular ring in parallel with said central axis, said boss comprising an axial throughhole.

30. A rotor assembly comprising a rotor shaft, a rotor winding mounted to said rotor shaft and comprising first and second winding leads, and a collector ring assembly mounted to said rotor shaft on one side of said winding, wherein said first and second winding leads respectively pass through first and second tunnels formed in said collector ring assembly.

31. The rotor assembly as recited in claim 30, wherein said collector ring assembly comprises first and second electrically conductive collector rings supported by a body of electrically insulative material, said first and second tunnels being formed in said electrically insulative body.

32. The rotor assembly as recited in claim 31, wherein said electrically insulative body further comprises a bore penetrated by said rotor shaft.

33. The rotor assembly as recited in claim 32, wherein each of said first and second collector rings comprises a circular ring and a boss, said circular rings being substantially coaxial with said rotor shaft.

34. The rotor assembly as recited in claim 33, wherein said boss of said first collector ring projects generally axially toward and into a space bounded by said circular ring of said second collector ring, while said boss of said second collector ring projects generally axially toward and into a space bounded by said circular ring of first collector ring.

35. The rotor assembly as recited in claim 30, wherein said first collector ring comprises a first hole and said second collector ring comprises a second hole, further comprising a first fastener engaged in said first hole and a second fastener engaged in said second hole, a portion of said first winding lead being wrapped around a first portion of said first fastener and clamped by a second portion of said first fastener, while a portion of said second winding lead being wrapped around a first portion of said second fastener and clamped by a second portion of said second fastener.
